(19) United States
(12) Patent Application Publication
(10) Pub. No.: US 2025/0158090 A1
(43) Pub. Date: May 15, 2025

(54) SEPARATOR PLATE FOR AN ELECTROCHEMICAL SYSTEM AND ASSOCIATED ASSEMBLY COMPRISING A PLURALITY OF SEPARATOR PLATES

(71) Applicant: Reinz-Dichtungs-GmbH, Neu-Ulm (DE)

(72) Inventors: Arun RAMACHANDRAN, Blaustein (DE); Andre SPEIDEL, Bussmannshausen (DE)

(21) Appl. No.: 18/945,321

(22) Filed: Nov. 12, 2024

(30) Foreign Application Priority Data
Nov. 13, 2023 (DE) 20 2023 106 627.5

(51) Int. Cl. H01M 8/026; H01M 8/0254; H01M 8/0263; H01M 8/0267; H01M 8/1004

(52) U.S. Cl. CPC H01M 8/026; H01M 8/0254; H01M 8/0263; H01M 8/0267; H01M 8/1004

(57) ABSTRACT

The present disclosure relates to a separator plate for an electrochemical system comprising first and second individual plates and an arrangement comprising at least one such separator plate. The first plate has first channels for guiding media separated by first webs. On a side facing the second plate, the first channels form first protrusions and the first webs form first grooves. The second plate has second channels separated by second webs. On a side facing the first plate, the second channels form second protrusions and the second webs form second grooves. The second protrusions project into the first grooves and the first protrusions project into the second grooves. The first and/or second grooves are stepped transversely to their longitudinal extension with a region of reduced groove depth, forming a support structure. The region of reduced groove depth contacts an opposite protrusion of the other plate.

### CROSS REFERENCE TO RELATED APPLICATION

This application claims priority to German Utility Model Application No. 20 2023 106 627.5, entitled “SEPARATOR PLATE FOR AN ELECTROCHEMICAL SYSTEM AND ASSOCIATED ASSEMBLY COMPRISING A PLURALITY OF SEPARATOR PLATES”, filed Nov. 13, 2023. The entire contents of the above-identified application is hereby incorporated by reference for all purposes.

### TECHNICAL FIELD

The present disclosure relates to a separator plate for an electrochemical system and an arrangement comprising at least one such separator plate.

### BACKGROUND AND SUMMARY

Known electrochemical systems, for example fuel cell systems or electrochemical compressor systems, redox flow batteries and electrolyzers, usually comprise a plurality of separator plates which are arranged in a stack, such that in each case two adjacent separator plates enclose an electrochemical cell. The separator plates usually each comprise two individual plates which are connected to one another along their rear sides facing away from the electrochemical cells. The separator plates can be used, for example, for electrically contacting the electrodes of the individual electrochemical cells (e.g. fuel cells) and/or for electrically connecting adjacent cells (series connection of the cells).

The individual plates of the separator plates may comprise channel structures for supplying the cells with one or more media and/or for transporting media away from the cells. In the case of fuel cells, the media can be, for example, fuels (e.g. hydrogen or methanol), reaction gases (e.g. air or oxygen) or a coolant as supplied media, and reaction products and heated coolant as discharged media. Furthermore, the separator plates may serve for transferring the waste heat produced in the electrochemical cell, as is produced for instance during the conversion of electrical or chemical energy in a fuel cell, and may be configured to seal the various media channels or cooling channels in relation to one another and/or from the external environment. In the case of fuel cells, the reaction media, i.e. fuel and reaction gases, are normally conducted on the mutually averted surfaces of the individual plates, while the coolant is conducted between the individual plates. The bipolar plates usually have at least one or more through-openings. Through the through-openings, the media and/or the reaction products can be fed to the electrochemical cells bounded by adjacent separator plates of the stack, or into the cavity formed by the individual plates of the separator plate, or can be discharged from the cells or from the cavity. The electrochemical cells, in particular of a fuel cell, may, for example, each comprise a membrane electrode assembly (or MEA) with a respective polymer electrolyte membrane (PEM) and electrodes. The MEA can also have one or more gas diffusion layers (GDL), which are usually oriented towards the separator plates, in particular towards the separator plates of fuel cell systems and are designed, for example, as a carbon fleece. By way of example in a fuel cell, hydrogen carried on an anode side is typically converted to water, with oxygen being carried on a cathode side. Protons produced during the oxidation of hydrogen pass from the anode side through the MEA to the cathode, where they react with the oxygen and electrons to form water. The membrane of the fuel cell is electrically insulating and prevents an electrical short circuit between the anode and cathode. The electrons are guided separately from the anode to the cathode so that the electric current can be utilized.

In application areas of electrochemical systems, particularly in the automotive or aviation sectors, high demands are placed on the installation space required by the electrochemical system and on the weight of the system.

The object of the present disclosure is therefore to propose an improved separator plate and/or an improved arrangement comprising a plurality of separator plates, in particular in such a way that a reduced installation space of the separator plate and/or the arrangement is achieved and/or a reduced weight of the coolant that is guided in the separator plate. Additionally or alternatively, it can be an object to reduce the coolant requirement.

According to the present disclosure, this object is at least partially solved by a separator plate and/or an arrangement having the features described herein.

The proposed separator plate for an electrochemical system comprises a first individual plate and a second individual plate connected to the first individual plate.

On a side that faces away from the second individual plate, the first individual plate has integral first channels for guiding the media, wherein the first channels extend next to each other and are separated from one another by first webs formed between the first channels.

On a side of the first individual plate that faces the second individual plate, the first channels form first elevations and the first webs form first grooves.

On a side that faces away from the first individual plate, the second individual plate has integral second channels for guiding the media, wherein the second channels extend next to each other and are separated from one another by second webs formed between the second channels.

On a side of the second individual plate that faces the first individual plate, the second channels form second protrusions and the second webs form second grooves.

The first individual plate is arranged opposite the second individual plate in such a way that the second protrusions project into the first grooves at a first distance and the first protrusions project into the second grooves at a second distance.

At least one of the first grooves and/or at least one of the second grooves is/are, in a section along their longitudinal extension, stepped transverse to their longitudinal extension with an area of reduced groove depth—forming a support structure—wherein the region with reduced groove depth contacts the opposite protrusion of the other individual plate to support the first individual plate on the second individual plate.

The support structure therefore corresponds to the region of reduced groove depth. The reduced groove depth results in particular versus a maximum or standard and therefore nominal groove depth.

The longitudinal extension of the first groove corresponds in particular to the longitudinal extension of the first channels and/or second channels. The longitudinal extension of the second groove corresponds to the longitudinal extension of the first and/or second channels. In the following description, unless it is explicitly stated whether the support structures of the first individual plate or the support structures of the second individual plate are involved, the features described apply to the support structures of the first individual plate and/or to the support structures of the second individual plate.

Optionally, the proposed arrangement enables a continuous cavity to be formed between the first individual plate and the second individual plate. If the separator plate is arranged in an electrochemical system, coolant can be introduced into this cavity to cool the individual plates.

The proposed structure of the separator plate allows for an advantageous nesting of the individual plates, which reduces the height of one component. Deformations of the separator plate during operation in an electrochemical system can be reduced or prevented by partially supporting the individual plates on corresponding other individual plates via the support structures. Furthermore, a volume of a cavity between the individual plates can be reduced, which leads to a reduction of the amount of coolant required when the separator plates are used in an electrochemical system. By reducing the amount of coolant, the total weight of the electrochemical system can be reduced.

There are already nested arrangements in the prior art. However, the known arrangements are nested in such a way that web areas are not or are insufficiently flushed with coolant and local temperature overloads occur at the MEA. This can lead to failure of the electrochemical system.

In one embodiment, a plurality of support structures may be formed in one of the first grooves and/or in one of the second grooves. The support structures within a groove can be spaced apart from each other. Optionally, within at least one channel, at least two support structures are arranged distanced to one another. When considering the extension direction of the channel as x-direction and the direction extending in the plane of the plate orthogonal to the x-direction as y-direction, then the support structures which are closest to each other with respect to the x-dimension and which have a distance of at the most five grooves from each other in the y-direction are optionally distanced by at least 3 mm and at most 100 mm.

A plurality of first grooves and/or a plurality of second grooves can each form at least one such support structure. Optionally, a plurality of first grooves and/or a plurality of second grooves can each form a plurality of such support structures. The support structures can improve the stability of the separator plate and at the same time enable surface cooling.

A contact plane, in which the area with reduced depth touches the opposite protrusion of the other individual plate for supporting the first individual plate on the second individual plate, can be inclined with respect to the flat surface plane, by a maximum of 15°, optionally by a maximum of 10°, optionally by a maximum of 5°.

In one embodiment, the first channels can run parallel to each other at least in sections, optionally completely. Additionally or alternatively, the first channels can be at least partially or completely undulating, for example, uniformly undulating. Additionally or alternatively, the second channels can run parallel to each other at least in sections, optionally completely. Additionally or alternatively, the second channels can be at least partially or completely undulating, for example, uniformly undulating. The first channels can run parallel to the second channels at least in sections, optionally completely.

In one embodiment, the first and second channels and first and second webs can have a straight course. Alternatively, the first and second channels and first and second webs can have an undulating or partially curved shape.

In one embodiment, the first individual plate can be the same as the second individual plate, for example to reduce manufacturing costs.

The first channels and the second channels can have main directions of extension which are oriented parallel to the respective flat surface plane and parallel to each other.

The flat surface plane can also be referred to as the plate plane. It may correspond to a plane of the non-deformed areas of the plate or to the plane of the outer edge of the plate or a plane parallel to one of them.

In one embodiment, a width of the support structure measured transversely, optionally orthogonally to the longitudinal extension of the respective groove can decrease and increase again over the course of the support structure along the longitudinal extension of the groove. The width of the support structure measured transversely to the longitudinal extension of the respective groove can be constant in sections along the course of the support structure along the longitudinal extension of the groove.

A minimum width of the support structure can be at least 0.3 times and/or at least 0.4 times and/or at least 0.5 times the width of a groove. A maximum width of the support structure can be at most 0.9 times and/or at most 0.8 times and/or at most 0.7 times a groove width. The groove width can be measured at the bottom of the groove. Alternatively, it is possible to measure the groove width—in each case for all groove widths to be compared—in the region of the inflection points of the flanks between grooves and adjacent protrusions or at half the height of a flank section
when viewing the grooves or channels and protrusions or webs in cross-section—in which the inflection points are located or which are bounded by two inflection points.

A minimum length of the support structure can be at least 2 mm and/or at least 2.5 mm or when considered in a relative manner, at least 0.3 times and/or at least 0.4 times and/or at least 0.5 times a groove width. A maximum length of the support structure can be at most 5 mm, and/or at most 4 mm and/or at most 3.5 mm or if considered in a relative manner at most 5 times and/or at most 3 times and/or at most 2 times a groove width. The groove width and the length of the support structure can be measured at the bottom of the groove. Alternatively, it is possible to measure the groove widths and lengths of the support structure—in each case for all grooves or support structures—in the region of the inflection points of the flanks between grooves and adjacent protrusions or in the area of the inflection points in the rising or descent area of the support structures or at half the height of a straight flank section—when viewing the grooves and protrusions in cross-section or the support structures in longitudinal section—in which the inflection points are located or which are bounded by two inflection points.

The support structures arranged in parallel grooves of the first and/or second individual plate can be arranged in such a way that at least some of the support structures are arranged in at least one row transverse to the longitudinal groove extension. All or some of the support structures of such a row of support structures arranged transversely to the longitudinal groove extension can be of the same design and/or can have different shapes. Additionally or alternatively, all or some of the support structures in a row along a groove extension can be of the same design and/or can have different shapes.

In one embodiment, the support structures of the first groove and/or the second groove can, along the longitudinal course of the respective groove, alternately originate from a first groove flank and a second groove flank that delimit the respective groove. The support structure is spaced from the other groove flank.

In a groove course, the support structures can all originate from the same groove flank that delimits the respective groove. In adjacent grooves each having support structures, the support structures in one groove can originate from the same groove flank, e.g. the respective right flank and in one or more further groove(s), for example an adjacent groove, the support structures can all originate from the other groove flank, e.g. the respective left flank. Grooves without support structures can be arranged between grooves with support structures.

The arrangement and shape of the support structures can be advantageous in order to influence the flow behavior of the cooling medium, in particular to guide a cooling medium and/or to counteract turbulence.

The first and/or second individual plate can optionally have a first, a second, and a third region, wherein the support structures in the first region are arranged offset to one another, the support structures in the second region are arranged in rows transversely to the course of the channel, and the support structures in the third region are arranged offset to one another.

The first, second and third regions can, for example, be arranged consecutively along the main flow direction. As already described above with regard to the shape of the support structures, the support structures can additionally or alternatively be set in a pattern that can serve to direct the coolant, for example from an edge region of the flow field to a center of the flow field.

The regions of reduced groove depth that form the support structures and that are distributed across the flow field can have different groove depths. For example, two or more regions of reduced groove depth can be formed in which support structures of the same groove depth are arranged.

The first and/or the second individual plate may optionally have a first, a second, and a third region, wherein the support structures in the first region have a region of reduced groove depth with a first depth, and the support structures in the second region have a region of reduced groove depth with a second depth. The first depth can be unequal to the second depth. In addition, the support structures in the third region may have a region of reduced groove depth with a third depth, and the third depth may be unequal to the first and/or the second depth.

For example, a centrally arranged region can be designed in such a way that in this centrally arranged region the regions of reduced groove depth have an even greater difference in depth compared to the regions of nominal groove depth, for example, they may be very shallow. This allows the protrusions of the other individual layer to penetrate less deeply into these groove sections, resulting in a locally thicker separator plate overall. This at least partially or completely compensates for end plate deflection in this central region.

In one embodiment, both individual plates, i.e. the first and the second individual plate, can have support structures. The support structures of the first individual plate can be arranged offset, in an orthogonal projection onto the second individual plate, to the support structures of the second individual plate.

Each individual plate can have at least two openings for the passage of a fluid, a flow field and two transition regions. A first one of the transition regions can be a distributor region and can be arranged between a first one of the through-openings and the flow field. A second one of the transition regions can be located between the flow field and a second one of the through-openings and can be a collection region. The transition regions can fluidically connect the through-openings with the flow field. The flow field can be an electrochemically active region. The support structures can be arranged in the active region of the first and/or the second individual plate, optionally only in the active region.

The first channels and the second channels can be arranged in the electrochemically active region of the separator plate, whereby the first webs and the second webs can form contact areas for a membrane electrode unit, for example, a gas diffusion layer of the membrane electrode unit.

In the present case, the term “electrochemically active region” or “active region” can be used to designate the region of the individual plate that is opposite an electrochemically active region of the MEA when the individual plate is arranged in an electrochemical system. In particular, the membrane of the MEA extends at least over the electrochemically active region of the adjacent separator plates and enables a proton transfer over or through the membrane. The actual electrochemically active region can be limited by the edge section of the MEA.

In one embodiment, a height of the separator plate measured perpendicular to a plane surface of the separator plate can be less than the sum of the material thicknesses of the two individual plates and twice the maximum channel base depth. That is, the height of the separator plate may be less than the combined thicknesses of the two individual plates plus twice the maximum channel base depth. The maximum channel base depth corresponds to the maximum height of a protrusion and also the maximum depth of a groove, i.e. the nominal groove depth in the individual plate in which this maximum channel base depth is greater than in the other individual plate. However, the maximum channel base depth can also be identical in both individual plates.

The first individual plate and the second individual plate can each have a plate body made of a metal, whereby the first channels and the second channels are molded, for example, embossed, into the respective plate body.

The separator plate can be rotationally symmetrical by 180° in the plane of the separator plate, at least in sections. For example, the passage openings and transition regions can be designed to be rotationally symmetrical, while the regions of the flow fields are not designed to be rotationally symmetrical. In an arrangement for an electrochemical system, this enables an advantageous mutual reinforcement of the effect of the individual structures without having to dispense with the use of identical parts for the respective first individual plates and the respective second individual plates.

The present disclosure further relates to an arrangement for an electrochemical system comprising a plurality of separator plates as described above. For example, MEAs and possibly GDLs are arranged between adjacent, i.e. closest, separator plates.

Neighboring separator plates can be arranged in such a way that they are rotated by 180° relative to each other in the plane of one of the separator plates. With a suitable design of the structures of the separator plates, and rotation—in its plane by 180°—, of for example each separator plate to be arranged alternately to a non-rotated separator plate, results in an overall arrangement in which the webs and channels or grooves and elevations of two separator plates arranged adjacent to each other are offset in a common plane in orthogonal projection. However, the support structures can also be arranged in such a way that they are not rotationally symmetrical.

Some or all of the separator plates can be designed such that, in an orthogonal projection of a first separator plate onto an adjacent separator plate, support structures of the first separator plate are arranged at least in regions of the adjacent separator plate in which support structures of the second separator plate are arranged.

Additionally or alternatively, some or all of the separator plates can be designed in such a way that, in an orthogonal projection of the support structures of a first separator plate onto an adjacent separator plate, support structures of the first separator plate are arranged offset, at least in some regions, relative to support structures of the adjacent separator plate. This can allow the membrane to be exposed to no or to reduced shear stress between the webs.

Optionally, the arrangement can also comprise adjacent separator plates that have support structures arranged offset to one another in an orthogonal projection and have overlapping support structures in some regions.

In one embodiment of the arrangement, at least one neighboring separator plate that does not have such support structures can be arranged adjacent to a separator plate having first support structures.

Adjacent to a separator plate having first support structures, at least one neighboring separator plate can be arranged which—in an orthogonal projection of the support structures of the first separator plate onto the neighboring separator plate—has no support structures, at least in those regions which in the orthogonal projection overlap with the support structures of the first separator plate. Similarly, the separator plates at the ends of a stacked arrangement, for example only the last separator plate in each case, can be designed with support structures, while the separator plates provided centrally in the arrangement can be designed without support structures.

Examples of the proposed separator plate and the proposed arrangement are shown in the figures and are explained in more detail in the following description.

### BRIEF DESCRIPTION OF THE FIGURES

FIG. 1 schematically shows, in a perspective view, an electrochemical system comprising a plurality of separator plates arranged in a stack.

FIG. 2 schematically shows, in a perspective view, two separator plates of the system according to FIG. 1 with a membrane electrode assembly (MEA) arranged between the separator plates.

FIG. 3 schematically shows a cross-section through a plate stack of a system in the manner of the system according to FIG. 1.

FIG. 4A schematically shows a section of an active region of a separator plate of a system of the type according to FIG. 1.

FIG. 4B schematically shows a cross-section through the section shown in FIG. 4A along section line B-B.

FIG. 4C schematically shows a cross-section through the section shown in FIG. 4A along section line C-C.

FIG. 4D schematically shows a cross-section through a section shown in FIG. 4A along section line D-D.

FIG. 4E schematically shows a perspective view of the section shown in FIG. 4A in a rotated view.

FIG. 5A schematically shows a section of an active region of a separator plate of a system of the type shown in FIG. 1.

FIG. 5B schematically shows a cross-section through the section shown in FIG. 5A along section line E-E.

FIG. 5C schematically shows a cross-section through the section shown in FIG. 5A along section line F-F.

FIG. 5D schematically shows a cross-section through a section shown in FIG. 5A along section line G-G.

FIG. 6 schematically shows a cross-section through an arrangement for an electrochemical system with a section of a plate stack of a system of the type shown in FIG. 1.

FIG. 7 schematically shows a cross-section through a further arrangement for an electrochemical system with a section of a plate stack of a system of the type shown in FIG. 1.

FIG. 8 schematically shows a cross-section through a further arrangement for an electrochemical system with a section of a plate stack of a system of the type shown in FIG. 1.

FIG. 9 schematically shows a top view of a section of an active region of a separator plate of a system of the type shown in FIG. 1.

### DETAILED DESCRIPTION

Here and below, features that recur in different figures are denoted in each case by the same or similar reference signs.

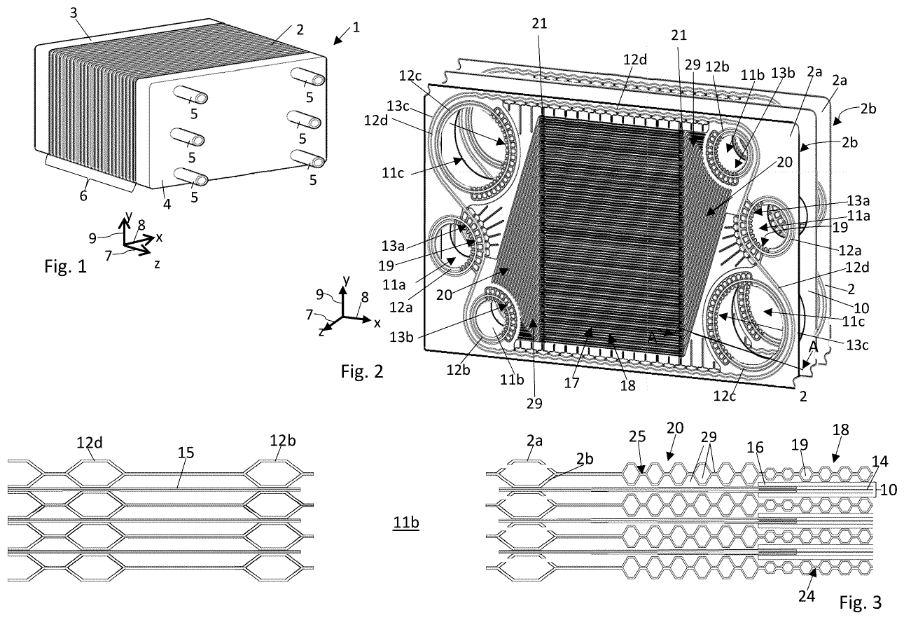

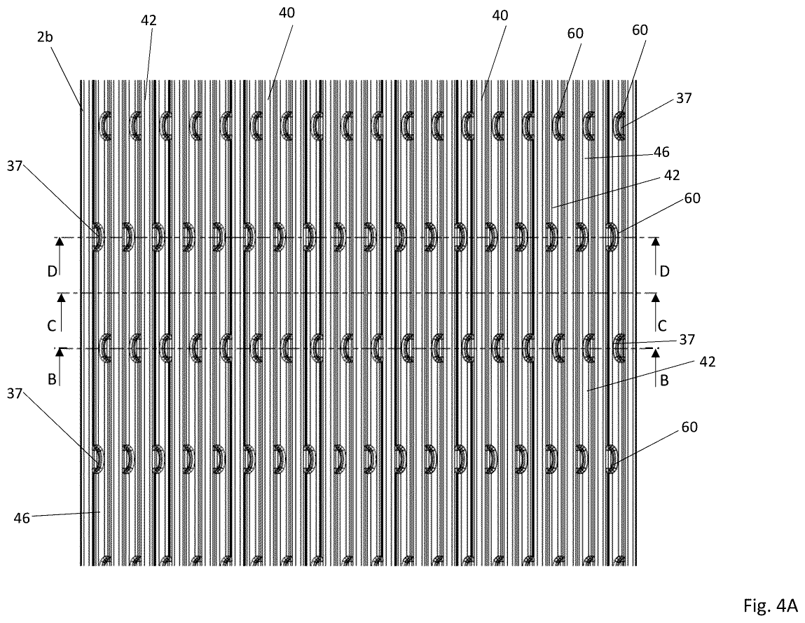

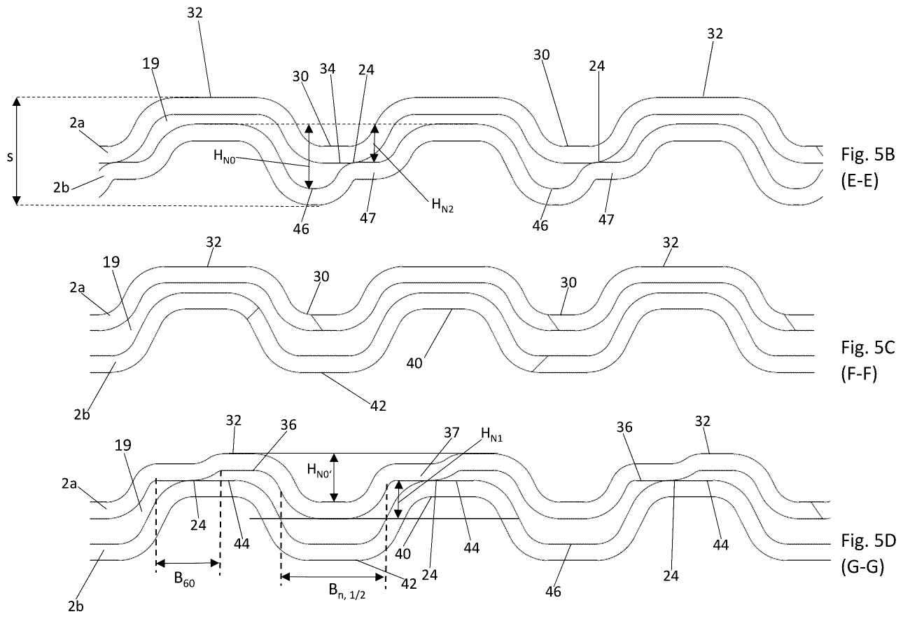

FIG. 1 shows an electrochemical system 1 comprising a plurality of structurally identical metal separator plates 2, which are arranged in a stack 6 and are stacked along a z-direction 7. The separator plates 2 of the stack 6 are clamped between two end plates 3, 4. The z-direction 7 is also referred to as the stacking direction. In the present example, the system 1 is a fuel cell stack. Two adjacent separator plates 2 of the stack enclose an electrochemical cell between them, which is used, for example, to convert chemical energy into electrical energy. To form the electrochemical cells of system 1, a membrane electrode assembly (MEA) 10 is arranged between adjacent separator plates 2 of the stack (see e.g. FIG. 2 or FIGS. 6 to 8). Each MEA 10 typically contains at least one membrane, for example an electrolyte membrane. Furthermore, a gas diffusion layer (GDL) can be arranged on one or both surfaces of the MEA, not shown in FIGS. 1 and 2 but can be seen, for example, in FIGS. 6 to 8.

In alternative embodiments, the system 1 may equally be in the form of an electrolyzer, an electrochemical compressor or a redox flow battery. In these electrochemical systems, use may likewise be made of separator plates. The structure of these separator plates can then correspond to the structure of the separator plates 2 described in more detail here, even if the media fed onto or through the separator plate in an electrolyzer, in an electrochemical compressor or in a redox flow battery may differ in each case from the media used for a fuel cell system.

The z-axis 7 together with an x-axis 8 and a y-axis 9 defines a right-handed Cartesian coordinate system. The separator plates 2 each define a plate plane, whereby the plate planes of the individual plates 2a, 2b are each aligned parallel to the x-y plane and thus perpendicular to the stacking direction or to the z-axis 7. The end plate 4 comprises a plurality of media connections 5, via which media can be fed to the system 1 and via which media can be discharged from the system 1. These media which can be fed to the system 1 and which can be discharged from the system 1 may comprise, for example, fuels such as molecular hydrogen or methanol, reaction gases such as air or oxygen, reaction products such as water vapor, or depleted fuels or coolants such as water and/or glycol.

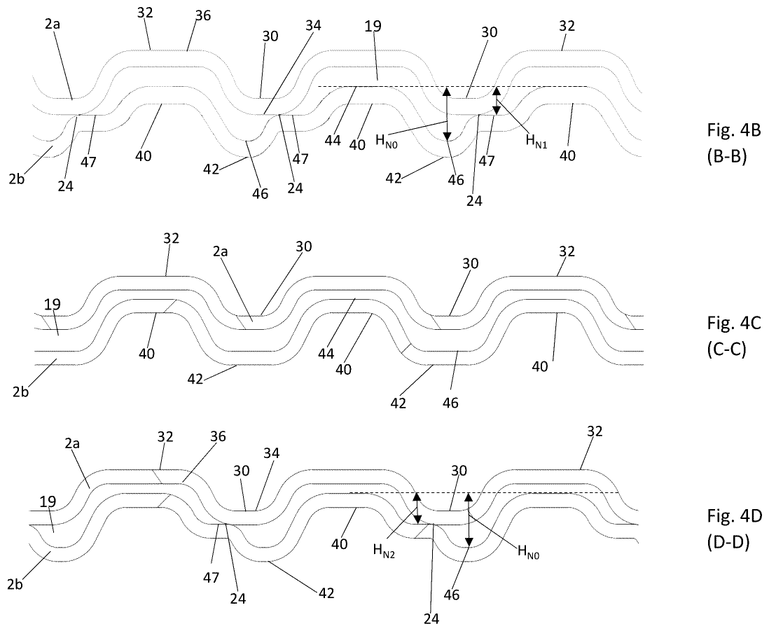

FIG. 2 shows, in perspective form, two adjacent separator plates 2 of an electrochemical system of the type of the system 1 of FIG. 1 and a membrane electrode assembly (MEA) 10 known from the prior art which is arranged between these adjacent separator plates 2, the MEA 10 being largely concealed in FIG. 2 by the separator plate 2 that faces the observer. The separator plate 2 is formed from two individual plates 2a, 2b that are joined together in a materially bonded manner (see for example FIG. 3), of which only the first individual plate 2a that faces the observer and that conceals the second individual plate 2b is visible in FIG. 2. The individual plates 2a, 2b may each be manufactured from a metal sheet, e.g. from a stainless-steel sheet. The individual plates 2a, 2b may, for example, be welded to one another, e.g. by laser welded joints. On the one hand, the individual plates 2a, 2b can be tightly welded along and at a distance from their outer edges or at least along the inner edge of a part of the through-openings along sealing seams, in particular outside and/or inside the perimeter bead 12d. Further weld seams are possible.

The individual plates 2a, 2b comprise through-openings which are aligned with one another and which form through-openings 11a-c in the separator plate 2. When a plurality of separator plates of the type of the separator plate 2 are stacked, the through-openings 11a-c form ducts which extend in the stacking direction 7 through the stack 6 (see FIG. 1). Typically, each of the ducts formed by the through-openings 11a-c is fluidically connected to one of the ports or media connections 5 in the end plate 4 of the system 1. By way of the ducts formed by the through-openings 11a, it is possible for e.g. coolant to be introduced into the stack or discharged from the stack. By contrast, the ducts formed by the through-openings 11b, 11c may be configured to supply the electrochemical cells of the fuel cell stack 6 of the system 1 with fuel and with reaction gas and to discharge the reaction products from the stack. The media-conducting through-openings 11a-11c are substantially parallel to the plate plane.

In order to seal the through-openings 11a-c in relation to the interior of the stack 6 and in relation to the environment, the first individual plates 2a each comprise sealing arrangements in the form of sealing beads 12a-c, which are each arranged around the through-openings 11a-c and which each completely enclose the through-openings 11a-c. The second individual panels 2b have corresponding sealing beads for sealing the through-openings 11a-c on the rear side of the individual panels 2 that face away from the viewer of FIG. 2 (not shown). Alternatively, elastomer seals can also be used.

In an electrochemically active region 18, the first individual plates 2a each have, on their side that faces the viewer of FIG. 2, a flow field 17 with structures for guiding a reaction medium along the outer side of the individual plate 2a. These structures are given in FIG. 2 by a plurality of webs 32, 42 and channels 30, 40 extending between the webs 32, 42 and bounded by the webs 32, 42. On the respective outer side of each of the separator plates 2 that faces the viewer in FIG. 2, the first individual plates 2a also each have a distribution and collection region 20. Distribution or collection regions 20 each comprise structures which are set up to distribute a medium introduced into the distribution region 20 from a first of the two through-openings 11b via the active region 18 or to collect or bundle a medium flowing from the active region 18 towards the second one of the through-openings 11b. The fluid-guiding structures 29 of both distribution or collection regions 20 are likewise provided in FIG. 2 by webs and channels which run between the webs and which are delimited by the webs. In the following text, only the distribution region 20 will be discussed for the sake of simplicity; the corresponding statements can equally apply to a collection region 20.

The sealing beads 12a-12c have feedthroughs 13a-13c, which allow passage of medium between the associated through-openings 12a-12c and the distribution region 20 on one gas side or in the interior of the separator plate 2.

The first individual plates 2a also each comprise a further sealing arrangement in the form of a perimeter bead 12d that runs around the flow field 17 of the active region 18, the distribution and collection regions 20 and the through-openings 11b, 11c and seals them off from the through-opening 11a, i.e. from the coolant circuit, and from the environment of the system 1. The second individual plates 2b each comprise corresponding perimeter beads. The structures of the active region 18, the distribution structures of the distribution and collection region 20 and the sealing beads 12a-d are each formed integrally with the individual plates 2a and molded into the individual plates 2a or 2b, e.g. in an embossing or deep-drawing process or by means of hydroforming.

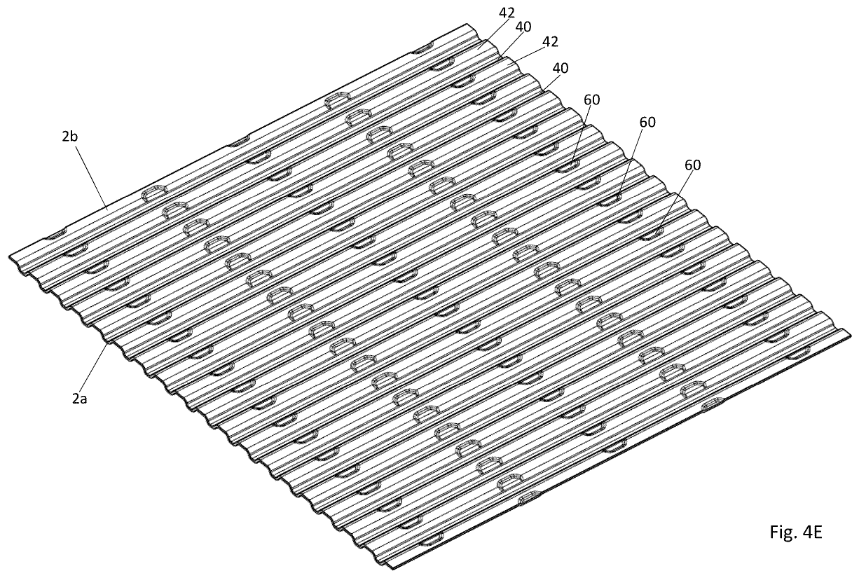

The separator plate 2 is formed from two individual plates, namely individual plates 2a, 2b, which are joined together with a material bond (see e.g. FIGS. 4 to 8), of which only the first individual plate 2a that faces the viewer is visible in FIG. 2, which conceals the second individual plate. The individual plates may each be formed of a shaped metal sheet, for example a stamped or deep-drawn stainless-steel sheet. This metal sheet may have, for example, a thickness of at most 150 μm, at most 100 μm, at most 90 μm, or at most 80 μm. The individual plates may be welded to one another, for example by laser-welded joints.

On its side that faces away from the second individual plate 2b, the first individual plate 2a has integral, adjacent first channels 30 for guiding the media, which are separated from one another by first webs 32 formed between the first channels 30. On a side of the first individual plate 2a that faces the second individual plate 2b, the first channels 30 form first protrusions 34 and the first webs 32 form first grooves 36. On its side that faces away from the first individual plate 2a, the second individual plate 2b has integral second channels 40 running next to one another for guiding the media, which are separated from one another by second webs 42 formed between the second channels 40. Here, on a side of the second individual plate 2b that faces the first individual plate 2a, the second channels 40 form second protrusions 44 and the second webs 42 form second grooves 46. The first individual plate 2a is arranged opposite the second individual plate 2b in such a way that the second protrusions 44 project into the first grooves 36 at a distance and the first protrusions 34 project into the second grooves 46 at a distance. The nested structure is particularly evident in the cross-sectional views in FIGS. 4B-4D, 5B-5D, 6, 7 and 8.

FIG. 3 schematically shows a cross-section through a portion of the plate stack 6 of the system 1 from FIG. 1, the cross-section plane being oriented in the z-direction and thus perpendicular to the plate planes of the separator plates 2. In FIG. 3, the cross-section plane runs along a bent section, along the sectional line A-A in FIG. 2. It should be noted that the separator plates in FIG. 3 are schematic and exemplary and serve to illustrate, in particular the different layers and regions, the structure of the electrochemical system. The nesting of the individual plates 2a, 2b, on the other hand, is not visible in FIG. 3.

Cooling channels are arranged in the cavity 19 between adjacent individual plates 2a, 2b. In the active region 18, the two individual plates 2a, 2b rest on each other in a contact region 24. The individual plates 2a and 2b can be connected to each other there.

A membrane electrode assembly (MEA) 10 known from the prior art, for example, is arranged between adjacent individual plates 2 of the stack. The MEA 10 typically comprises a membrane 14, e.g. an electrolyte membrane, and an edge portion 15 connected to the membrane 14. For example, the edge portion 15 can be bonded to the membrane 14, e.g. by an adhesive connection or by lamination.

In the present case, the term “electrochemically active region” is used to designate the region of the individual plate 2a, 2b that is opposite an electrochemically active region of the MEA 10 when the individual plate 2a, 2b is arranged in an electrochemical system. The membrane of the MEA 10 extends in each case at least over the active region 18 of the adjacent separator plates 2 and there enables a proton transfer over or through the membrane 14. The actual active region 18 is limited by the edge portion 15 of the MEA. This means that the membrane does not extend into the distribution or collection region 20. The edge portion 15 of the MEA 10 serves in each case for positioning, fastening and sealing the membrane between the adjoining separator plates 2.

The edge portion 15 in each case covers the distribution or collection region 20 of the adjoining separator plates 2. The edge portion 15 can also extend outwards beyond the perimeter bead 12d and adjoin or protrude beyond the outer edge region of the individual plates 2a, 2b (see FIG. 2).

Furthermore, gas diffusion layers 16 may additionally be arranged in the active region 18. The gas diffusion layers 16 enable flow over the largest possible region of the membrane surface and can thus improve the proton transfer across the membrane. The gas diffusion layers 16 can, for example, be arranged on both sides of the membrane 14 at least in the active region 18 between the adjacent separator plates 2. The gas diffusion layers 16 may be, for example, formed from a fiber felt or comprise a fiber felt.

FIG. 4A shows a view of a section of an active region 18 of a separator plate 2 of a system according to FIG. 1. In the top view shown of the first individual plate 2a, channels 40, webs 42 and regions 37 of reduced groove depth of the second individual plate 2b are visible. The first channels 30 and the second channels 40 run in a straight line and parallel to each other. The regions of reduced groove depth form support structures 60, only some of which are marked with reference symbols for the sake of clarity. A plurality of support structures 60 are arranged within the longitudinal extension of a groove 46, whereby these support structures 60 alternately originate, along the longitudinal groove extension, from one of the two lateral flanks delimiting the groove. In the top view shown, the support structures 60 all have the shape of a longitudinally cut oval. In other embodiments, the support structures may have a different shape. The shape of the support structures 60 of a separator plate 2 can vary, for example, along or transverse to the groove extension.

The support structures 60 are arranged in rows at right angles to the longitudinal groove extension. The support structures 60 of such a transverse row all originate from the same flank side of the flank delimiting the groove.

FIG. 4B shows a section of cross-section B-B (as shown in FIG. 4A) through the separator plate section of FIG. 4A. The first individual plate 2a is arranged on the second individual plate 2b. The cavity 19 is formed to accommodate a coolant. As described above, the first individual plate 2a has channels 30 and webs 32 delimiting the channels 30 on the side facing away from the second individual plate 2b. Similarly, the second individual plate 2b has channels 40 on the side facing away from the first individual plate 2a and webs 42 delimiting the channels 40. In the second individual plate 2b, the regions of reduced groove depth that form the support structures 60 are visible. A channel 40 is arranged between each of the support structures 60. The cross-section B-B runs approximately centrally through the support structures 60, so that the support structures are shown in the region of their greatest lateral extension. In contact regions 24, the first individual plate 2a rests on the second individual plate 2b. More precisely, the protrusion 34 in the contact regions 24 rests on the region 47 with a groove depth H_{N1} that is less than regions with a nominal height H_{N0}.

FIG. 4C shows a section of cross-section C-C (as shown in FIG. 4A) through the separator plate section of FIG. 4A. Cross-section C-C does not extend through support structures. The first individual plate 2a is arranged at a distance from the second individual plate 2b. In this cross-section, the individual plates 2a and 2b do not touch.

FIG. 4D shows a section of cross-section D-D (as shown in FIG. 4A) through the separator plate section of FIG. 4A. The cross-section extends through support structures 60 which, compared to those in FIG. 4B, originate from the opposite flank side of the respective groove 46. The support structures are embossed in the second individual plate 2b. The first individual plate 2a does not have any support structures 60 here either. In addition to regions of nominal height H_{N0}, the webs 42 also have regions of reduced height H_{N2}, namely where the support structures 60 are arranged. In the second region shown in FIG. 4D, for example, the reduced height H_{N2} is greater than the reduced height H_{N1} in the first region shown in FIG. 4B, for example, so it is less reduced. As a result, the protrusions of the other individual layer extend deeper into these groove sections, resulting in a locally thinner separator plate overall.

For example, the region of less reduced depth H_{N2} shown in FIG. 4D can optionally be arranged in a peripheral region of the separator plate, while the overall thicker region with more reduced depth H_{N1} from FIG. 4B can optionally be arranged in a central region of the separator plate. This can at least partially or completely compensate for end plate deflection in this central region.

FIG. 4E shows the section of the separator plate 2 shown in FIG. 4A in a rotated perspective view. In the section shown, the support structures 60 are evenly spaced apart. The support structures 60 of the example shown have a maximum length corresponding to twice the channel width and a maximum width corresponding to a maximum of 0.75 times the channel width. The channel width can be measured on a channel base, for example. Alternatively, it is possible to measure the channel width—in each case for all channel widths to be compared—in the region of the inflection points of the flanks between channels and adjacent webs or at half the height of a straight flank section—when viewing the channels and webs in cross-section—in which the inflection points are located or which are limited by two inflection points.

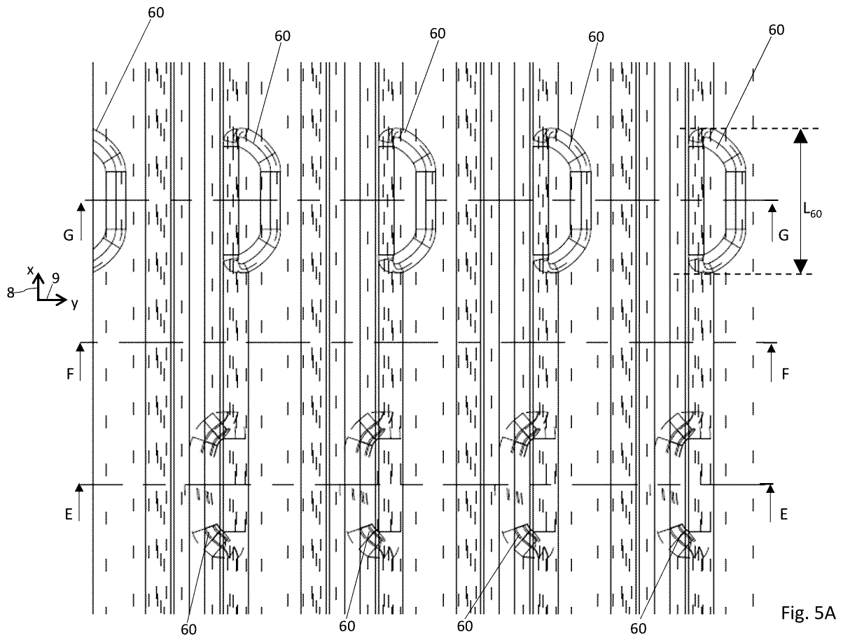

In the section shown in FIG. 5A of an exemplary separator plate 2 of the system of the kind of the system of FIG. 1, two rows of support structures 60 arranged after one another in x direction are recognizable. FIG. 5A shows a view through the first individual plate 2a and the second individual plate 2b. The first row of support structures 60, along which the cross-section G-G is drawn in FIG. 5A, is embossed into the first individual plate 2a. This can be seen in FIG. 5D, for example. While the second individual plate 2b has no support structures 60 in the region of cross-section G-G, the first individual plate 2a forms regions 37 with a reduced groove depth in the region of the protrusions 44. The support structures 60 of the first individual plate 2a are arranged offset, in an orthogonal projection onto the second individual plate 2b, to the support structures 60 of the second individual plate 2b, cf. FIG. 5B. The height of the webs 42 and channels 40 as well as the protrusions 44 and grooves 46 of the second individual plate 2b is constant. The maximum height of the webs 32 of the first individual plate is also constant. However, the webs 42 of the second individual plate 2b have, in addition to regions of nominal height H_{N0}, regions of reduced height H_{N2}, namely where the support structures 60 are arranged. In contact regions 24, the first individual plate 2a rests on the second individual plate 2b.

FIG. 5C shows a cross-section along the line F-F shown in FIG. 5A. No support structures 60 are arranged in the separator plate 2 along this section. In this region, the height of the webs 42 and channels 40 as well as the height of the protrusions 44 and grooves 46 of the second individual plate 2b is constant. The height of the webs 32 and channels 30 as well as the height of the protrusions 34 and grooves 36 of the first individual plate 2a is also constant. A height of the webs 32 is smaller than a height of the webs 42.

FIG. 5D shows the cross-section G-G through support structures 60 shown in FIG. 5A. The support structures are located in the first individual plate 2a. In contact regions 24, the protrusions 44 of the second individual plate 2b rest against grooves 36, wherein the grooves 36 in the contact regions 24 have a reduced depth H_{N1} compared to the nominal depth H_{N0′} of the first individual plate. The support structures 60 of the first individual plate 2a originate from an opposite flank (in FIG. 5A the left flank delimiting the groove) compared to the support structures 60 of the second individual plate 2b. In FIG. 5D an exemplary width B₆₀ of a support structure 60 as well as a width of a groove at half its height, B_{n, 1/2} are indicated; here, B₆₀ corresponds approximately to 0.6 times B_{n, 1/2}.

A comparison of FIGS. 5B and 5D also shows that the reduction in depth is more pronounced in FIG. 5B than in FIG. 5D.

The embodiment shown has the advantage that coolant can be passed directly under the webs 32 or 42, so that the web surfaces can be cooled. The nested structure also enables a low plate thickness s of the separator plate 2, which is shown as an example in FIG. 5B, compared to non-nested individual plates 2a, 2b, such as those shown in FIG. 3.

FIGS. 6 to 8 each show a schematic sectional view of an exemplary structure for the system of the type shown in FIG. 1. The section shown extends orthogonally to the plate plane and transversely to the longitudinal extension of the channel structures. A MEA 10 as described above is arranged between two separator plates 2, 2′. The MEA 10 comprises a membrane 14, which is covered by two gas diffusion layers, one on the front and one on the back. Each of the separator plates 2, 2′ comprises two individual plates 2a and 2b, which are supported in contact regions 24.

In FIG. 6, the first individual plate 2a of the separator plate 2 does not form any support structures 60 in the section shown. The second individual plate 2b of the separator plate 2, on the other hand, forms support structures 60 as described above. The second individual plate 2b touches the MEA 10, more precisely the gas diffusion layer 16, in contact areas 25. The separator plate 2′ is identical in design to the separator plate 2. The first individual plate 2a contacts the MEA 10 in contact areas 25, which correspond to an upper surface of the webs 32. The separator plates 2 and 2′ are arranged in such a way that the support structures 60 overlap in an orthogonal projection onto the flat surface plane.

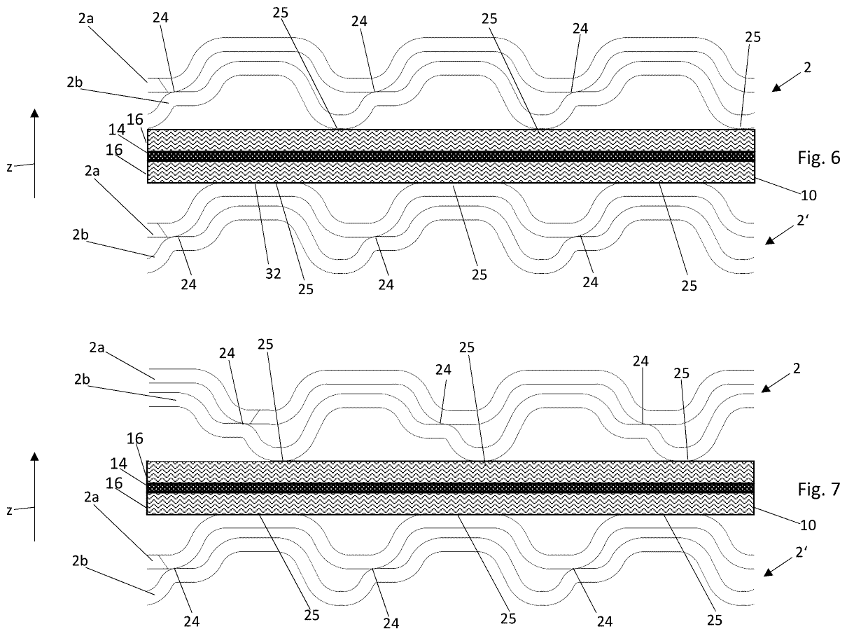

In FIG. 7, the first individual plate 2a of the separator plate 2 does not form any support structures 60 in the section shown. The second individual plate 2b of the separator plate 2, on the other hand, forms support structures 60 as described above. The second individual plate 2b touches the MEA 10, more precisely the gas diffusion layer 16, in contact areas 25. The separator plate 2′ is identical in design to the separator plate 2, at least in the region shown. The first individual plate 2a contacts the MEA 10 in contact areas 25, which corresponds to an upper surface of the webs 32. The separator plates 2 and 2′ are arranged in such a way that the support structures 60 are offset from one another in an orthogonal projection onto the flat surface plane. However, relative to the separator plate 2, the separator plate 2′ is rotated by 180° around an axis extending in the stacking direction z, thus in the plate plane, such that the support structures 60 in the separator plate 2 originate from the left groove flanks, while the support structures 60 in the separator plate 2′ originate from the right groove flanks. The separator plates 2 and 2′ are nevertheless identical parts, but they are only rotationally symmetrical in sections, particularly in the region of the passage openings and distribution regions, while the electrochemically active region is not rotationally symmetrical.

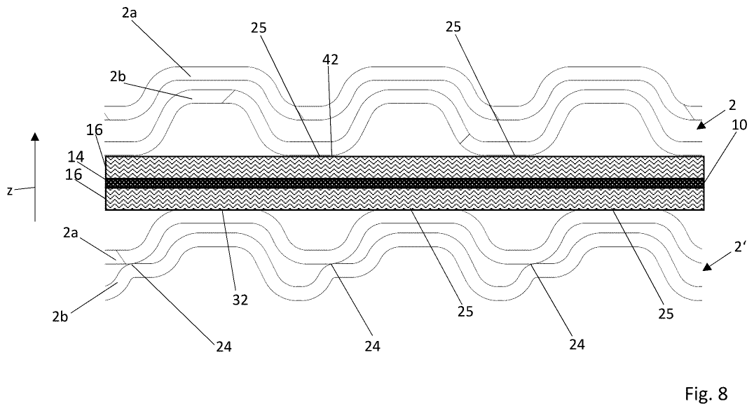

In FIG. 8, both the first individual plate 2a of the separator plate 2 and the second individual plate 2b of the separator plate 2 do not form any support structures 60 in the section shown. While the first individual plate 2a of the second separator plate 2′ also does not form any support structures 60, the second individual plate 2b of the separator plate 2′, on the other hand, has support structures 60 as described above. In contact areas 25, the second individual plate 2b of the separator plate 2 touches the MEA 10, more precisely the gas diffusion layer 16. The separator plate 2′ is identical in design to the separator plate 2′ in FIG. 7, at least in the region shown. The first individual plate 2a of the separator plate 2′ contacts the MEA 10 in contact areas 25, which correspond to an upper surface of the webs 32. The separator plates 2 and 2′ are arranged in such a way that the support structures 60 lie in an orthogonal projection onto the flat surface plane in the region of the webs 42 of the second individual plate 2b of the separator plate 2.

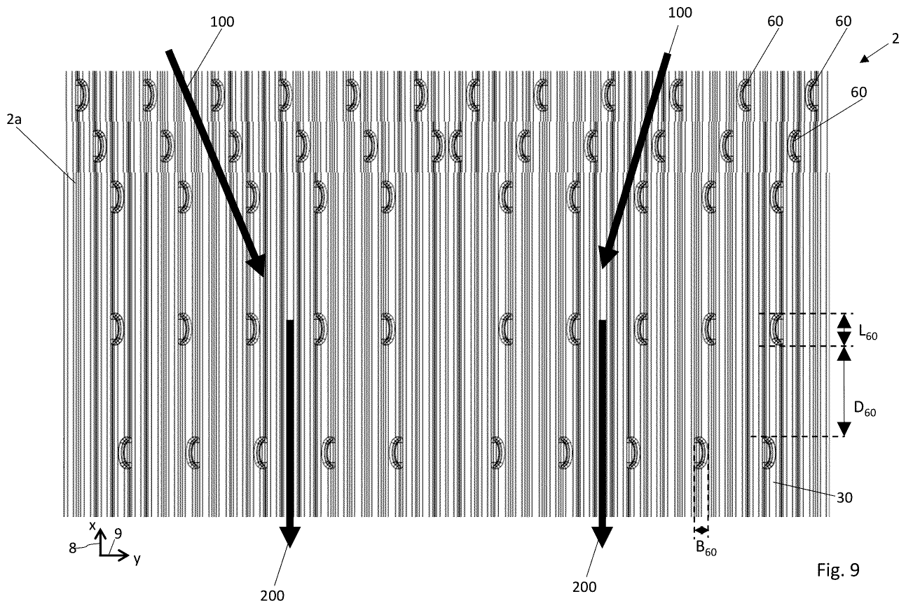

FIG. 9 shows an exemplary separator plate 2 as described in the above embodiment in a top view of the first individual plate 2a. The embodiments of the individual plates 2a, 2b described above with regard to the previous figures can be transferred to the present separator plate 2. In FIG. 9 an exemplary length L₆₀ and a width B₆₀ of a support structure 60 are shown as well as a distance D₆₀ between two support structures being distanced less than five grooves from each other in y direction with shortest distance to each other in x direction, thus support structures being closest to one another. The length L₆₀ amounts to about 2.2 times the width B₆₀.

Within e.g. the channel 30, at least two support structures 60 are formed, which are distanced to one another in the x-direction by a distance D₆₀. This distance D₆₀ here corresponds to about 2.7 times the length L₆₀. With regards to absolute values, the length L₆₀ may amount to about 3 mm and the distance D₆₀ about 8.1 mm.

FIG. 9 shows in particular that the support structures 60, of which only some are provided with the reference symbols for the sake of clarity, can serve as guide structures. The support structures 60 are arranged relative to one another in such a way that a fluid flowing in the cavity 19 (which is concealed in the figure) between the individual plates 2a and 2b is directed by the support structures 60. Arrows 100 and 200 are drawn as examples to illustrate the direction of flow. In the upper region of FIG. 9, the support structures are arranged offset to each other so that a flow is achieved that runs at an angle to the elongated channel, see arrows 200. The flow is directed from the sides to a center. In a region of FIG. 9 further down, the centered flow is forwarded parallel to the channels 30 and 40, see arrows 200.

1. A separator plate for an electrochemical system, comprising a first individual plate and a second individual plate connected to the first individual plate,
wherein the first individual plate has first channels for guiding media, wherein the first channels are integrally formed on a side of the first individual plate that faces away from the second individual plate, wherein the first channels extend next to each other, and are separated from each other by first webs formed between the first channels,
wherein, on a side of the first individual plate that faces the second individual plate, the first channels form first protrusions and the first webs form first grooves,
wherein the second individual plate has second channels for guiding media, wherein the second channels are integrally formed on a side of the second individual plate that faces away from the first individual plate, wherein the second channels extend next to each other, and are separated from each other by second webs formed between the second channels,
wherein, on a side of the second individual plate that faces the first individual plate, the second channels form second protrusions and the second webs form second grooves,
wherein the first individual plate is arranged opposite the second individual plate in such a way that the second protrusions project into the first grooves at a first distance and the first protrusions project into the second grooves at a second distance,
wherein at least one of the first grooves and/or at least one of the second grooves, in a section along its longitudinal extension, is stepped transversely to its longitudinal extension with a region of reduced groove depth—forming a support structure—wherein the region of reduced groove depth contacts an opposite protrusion of the other individual plate to support the first individual plate on the second individual plate.

2. The separator plate according to claim 1, wherein a plurality of support structures are formed in one of the first grooves and/or in one of the second grooves.

3. The separator plate according to claim 1, wherein a plurality of first grooves and/or a plurality of second grooves each form at least one such support structure.

4. The separator plate according to claim 1, wherein a contact plane, in which the region of reduced depth contacts the opposite protrusion of the other individual plate to support the first individual plate on the second individual plate, is inclined with respect to a plate plane by a maximum of 15°.

5. The separator plate according to claim 1, wherein the first channels extend parallel to each other at least in sections, and/or wherein the second channels extend parallel to each other at least in sections, and/or wherein the first channels extend parallel to the second channels at least in sections.

6. The separator plate according to claim 1, wherein a width of the support structure, measured transversely to the longitudinal extension of the respective groove, decreases and increases again over the course of the support structure along the longitudinal extension of the groove.

7. The separator plate according to claim 1, wherein the support structures of the first groove and/or of the second groove along the longitudinal extension of the respective groove alternately originate from a first groove flank and a second groove flank that delimit the respective groove.

8. The separator plate according to claim 1, wherein the first individual plate and/or the second individual plate has a first region, a second region, and a third region, wherein the support structures in the first region are arranged offset from one another, the support structures in the second region are arranged forming rows transversely to the course of the channel, and the support structures in the third region are arranged offset from one another.

9. The separator plate according to claim 1, wherein the first individual plate and/or the second individual plate has a first region, a second region, and a third region, wherein the support structures in the first region have a region of reduced groove depth with a first depth, the support structures in the second region have a region of reduced groove depth with a second depth, wherein the first depth is not equal to the second depth, wherein the support structures in the third region have a region of reduced groove depth with a third depth and the third depth is not equal to the first depth and/or the second depth.

10. The separator plate according to claim 1, wherein the first individual plate has first support structures and the second individual plate has second support structures, wherein the first support structures of the first individual plate are arranged offset to the second support structures of the second individual plate in an orthogonal projection onto the second individual plate.

11. The separator plate according to claim 1, wherein a height of the separator plate, measured perpendicular to a plane of the separator plate, is less than a sum of material thicknesses of the first individual plate and the second individual plate and twice a maximum channel base depth.

12. The separator plate according to claim 1, wherein the first channels and the second channels are arranged in an electrochemically active region of the separator plate, wherein the first webs and the second webs form contact areas for a membrane electrode assembly or a gas diffusion layer of a membrane electrode assembly.

13. The separator plate according to claim 1, wherein the separator plate is at least in part rotationally symmetrical by 180° in a plane of the separator plate.

14. An arrangement for an electrochemical system, comprising a plurality of separator plates according to claim 1, wherein adjacent separator plates are rotated by 180° relative to each other in a plane of one of the separator plates.

15. An arrangement for an electrochemical system, comprising a plurality of separator plates according to claim 1, wherein the separator plates are designed such that, in an orthogonal projection of a first separator plate onto an adjacent separator plate, support structures of the first separator plate are arranged, at least in regions, in regions of the adjacent separator plate in which support structures of the adjacent separator plate are arranged.

16. An arrangement for an electrochemical system, comprising a plurality of separator plates according to claim 1, wherein the plurality of separator plates are configured such that in an orthogonal projection of the support structures of a first separator plate onto an adjacent separator plate, support structures of the first separator plate are arranged offset, at least in some regions, with respect to the support structures of the adjacent separator plate.

17. An arrangement for an electrochemical system, comprising a plurality of separator plates according to claim 1, wherein, adjacent to a first separator plate having first support structures, at least one adjacent separator plate is arranged which does not have such support structures,
or
wherein the at least one adjacent separator plate is arranged adjacent to the first separator plate having the first support structures, which—in an orthogonal projection of the first support structures of the first separator plate onto the adjacent separator plate—has no support structures at least in those areas which in the orthogonal projection overlap with the first support structures of the first separator plate.
